(19) United States
(12) Patent Application Publication
(10) Pub. No.: US 2014/0368039 A1
(43) Pub. Date: Dec. 18, 2014

(54) METHOD FOR PROVIDING CONTROL POWER, TAKING INTO ACCOUNT A VARIABLE TARGET FREQUENCY

(71) Applicants: Georg Markowz, Alzenau (DE); Carsten Kolligs, Bottrop (DE); Holger Brezski, Fernwald (DE); Anna Flemming, Frankfurt (DE); Dennis Gamrad, Voerde (DE); Sebastien Cochet, Oberhausen (DE)

(72) Inventors: Georg Markowz, Alzenau (DE); Carsten Kolligs, Bottrop (DE); Holger Brezski, Fernwald (DE); Anna Flemming, Frankfurt (DE); Dennis Gamrad, Voerde (DE); Sebastien Cochet, Oberhausen (DE)

(73) Assignee: Evonik Industries AG, Essen (DE)

(21) Appl. No.: 14/357,322

(22) PCT Filed: Oct. 30, 2012
(86) PCT No.: PCT/EP2012/071423

§ 371 Date: May 9, 2014

(30) Foreign Application Priority Data
Nov. 10, 2011 (DE) 10 2011 055 251.0

(51) Int. Cl. H02J 3/32

(52) U.S. Cl. CPC H02J 3/32
USPC 307/48

(57) ABSTRACT

A method for producing control power for stabilizing an AC electrical grid, wherein the AC electrical grid operates at a variable desired frequency and the AC electrical grid comprises at least one control power supplier which is controlled in a decentralized manner and which controls the grid frequency to a predefined frequency, wherein the predefined frequency is adapted to the desired frequency.

The present invention relates to a method for producing control power taking account of a variable desired frequency, and to a device for carrying out such a method.

Electrical grids are used to distribute electricity from usually a plurality of energy generators in large areas to many users and to supply households and industry with energy. Energy generators, usually in the form of power stations, provide the required energy for this purpose. In general, the generation of electricity is planned and provided with regard to the forecast consumption.

However, unplanned fluctuations can occur both during generation and during consumption of energy. On the energy generator side, said fluctuations can arise, for example, by virtue of a power station or part of the electrical grid failing or, for example in the case of renewable energies such as wind, by virtue of the generation of energy turning out to be higher than forecast. With regard to the consumers, too, unexpectedly high or low consumptions can occur. The failure of part of the electrical grid, for example, that cuts off some consumers from the energy supply can lead to a sudden reduction of the electricity consumption.

This generally has the effect that fluctuations in the grid frequency occur in electrical grids as a result of unplanned and/or momentary deviations of power generation and/or consumption. The desired AC frequency is 50 Hz in Europe, for example. A reduction in the consumption compared with the plan leads to an increase in the frequency when power is fed in as planned by the energy generators; the same applies to an increase in the production of electricity compared with the plan when consumption is as planned. By contrast, a reduction in the power from the energy generators compared with the plan leads to a reduction in the grid frequency when consumption is as planned; the same applies to an increase in the consumption compared with the plan when generation is as planned.

For reasons of grid stability, it is necessary to keep these deviations within a defined framework. For this purpose, depending on the magnitude and direction of the deviation, it is necessary to provide, in a targeted manner, positive control power by connecting additional generators or disconnecting consumers, or negative control power by disconnecting generators or supplementarily connecting consumers. There is generally a need for these control powers to be provided economically and efficiently, wherein the requirements in respect of the capacities to be kept available and the dynamic range of the control power sources and/or sinks can vary depending on the characteristic of the electrical grid.

In Europe there is, for example, a set of regulations (UCTE Handbook), describing three different categories of control power. The respective requirements and the types of control power are also defined therein. The types of control power differ, inter alia, in the requirements in respect of the dynamic range and the duration of power production. Moreover, they are used differently with regard to the boundary conditions. Primary control power (PCP) should be produced throughout Europe by all incorporated sources, independently of the location of the cause of the disturbance, to be precise substantially proportionally to the present frequency deviation. The maximum power in absolute terms should be produced in the case of frequency deviations of minus 200 mHz or less (in absolute terms); the minimum power in absolute terms should be produced in the case of frequency deviations of plus 200 mHz or more. With regard to the dynamic range it holds true that from the quiescent state the maximum power (in terms of absolute value) in each case must be provided within 30 seconds. By contrast, secondary control power (SCP) and minute reserve power (MRP) should be produced in the balance areas in which the disturbance occurred. Their task is to compensate for the disturbance as rapidly as possible and thus to ensure that the frequency is in the desired range again as rapidly as possible again, preferably at the latest after 15 minutes. With regard to the dynamic range, less stringent requirements are made of the SCP and the MRP (5 and 15 minutes, respectively, until full power production after activation); at the same time these powers should also be provided over longer periods of time than primary control power.

In the electrical grids operated heretofore, a large part of the control power is provided by conventional power stations, in particular coal and nuclear power stations. Two fundamental problems result from this. Firstly, the conventional power stations providing control power are not operated at full load and thus with maximum efficiencies, but rather slightly below same, in order to be able to provide positive control power as necessary, if appropriate over a theoretically unlimited period of time. Secondly, with increasing expansion and increasing preferred use of renewable energies, fewer and fewer conventional power stations are in operation, but this is often the basic prerequisite for producing control powers.

For this reason, approaches have been developed for the increasing use of stores in order to store negative control power and to provide it as positive control power as necessary.

The use of hydro pumped-storage pumps for producing control power is prior art. In Europe, all three types of control power mentioned above are produced by pumped-storage facilities. However, hydro pumped-storage facilities are also repeatedly being mentioned as currently the most economic technology for storing and outputting preferably renewable energies, in order to be able to adapt energy supply and demand better to one another over time. The potential for expanding storage capacities—particularly in Norway—is the subject of controversial discussion, since considerable capacities in power lines must be approved and installed for the utilization. Consequently, the utilization for load management economically in the energy sector is in competition with the provision of control power.

Against this background, in the area of primary control power, relatively recently, approaches have repeatedly been investigated and described with regard to using other storage technologies as well, such as flywheel and battery stores, for example, for providing control power.

US 2006/122738 A1 discloses an energy management system comprising an energy generator and an energy store, wherein the energy store can be charged by the energy generator. As a result, an energy generator that does not ensure uniform energy generation during normal operation, such as the increasingly favoured renewable energies, for example, such as wind power or photovoltaic power stations, is intended to be enabled to output its energy into the electrical grid more uniformly. What is disadvantageous about this is that by this means, although an individual power station can be stabilized, all other disturbances and fluctuations of the electrical grid cannot be brought under control or can be brought under control only to a very limited extent.

It is known from WO 2010 042 190 A2 and JP 2008 178 215 A to use energy stores for providing positive and negative control power. If the grid frequency leaves a tolerance range around the wanted grid frequency, either energy is provided from the energy store or is taken up in the energy store in order to regulate the grid frequency. DE 10 2008 046 747 A1 also proposes operating an energy store in an island electrical grid in such a way that the energy store is used to compensate for consumption peaks and consumption minima. What is disadvantageous about this is that the energy stores do not have the necessary capacity to compensate for a relatively long disturbance or a plurality of disturbances one after another that act in the same direction with regard to the frequency deviation.

In the article “Optimizing a Battery Energy Storage System for Primary Frequency Control” by Oudalov et al., in IEEE Transactions on Power Systems, Vol. 22, No. 3, August 2007, the dependence of the capacity of a rechargeable battery on technical and operational boundary conditions is determined in order that said battery can provide primary control power according to the European standards (UCTE Handbook). It is evident that the store is unavoidably charged or discharged repeatedly at different time intervals in the long term on account of the storing and outputting losses. In this respect, the authors propose the periods of time in which the frequency is in the dead band (i.e. in the frequency range in which no control power is to be produced). Nevertheless, in the short term or temporarily the situation can occur that the store is overcharged. The authors propose for such cases the (limited) use of loss-generating resistors which in the extreme case take up the complete negative nominal control power, that is to say have to be designed for that.

Besides the additional capital expenditure requirement for the resistors and the cooling thereof, this leads, however, as already mentioned by the authors themselves to more or less undesirable energy degradation, wherein the waste heat that arises generally cannot be utilized. The authors demonstrate that reduced recourse to loss generation is possible only by means of a higher storage capacity, associated with higher capital expenditure costs.

Rechargeable batteries and other energy stores can take up or output energy very rapidly, as a result of which they are suitable, in principle, for providing PCP. What is disadvantageous about this, however, is that very large capacities of the rechargeable batteries have to be provided in order to be able to supply the control power also over a relatively long period of time or repeatedly. However, rechargeable batteries having a very high capacity are also very expensive.

On account of the losses during the storing and outputting of energy, the energy store, such as a rechargeable battery for example, is discharged earlier or later in the event of statistically symmetrical deviation of the grid frequencies from the desired value as a result of operation. Therefore, it is necessary to charge the energy store more or less regularly in a targeted manner. This charging current may need to be paid for separately.

The relatively constant grid frequency of AC electrical grids that are controlled according to the methods set out above, for example, can be used as a timer for determining a so-called grid or synchronous time, or else for operating clocks. However, owing to the fact that the frequency deviations are not distributed ideally symmetrically around the value zero statistically, in particular over relatively short periods of time of from a few hours to days, deviations of the grid time from the co-ordinated universal time occur, the latter being determined by means of atomic clocks nowadays. If positive deviations of the frequency from the desired value predominate over a period of time, for example, then the grid time leads the universal time. Conversely, the grid time lags behind the universal time in the event of predominantly negative frequency deviations. In order that the grid time determined over the AC electrical grid is allowed to deviate from the universal time only to a limited extent or in order that the clocks possibly regulated according thereto are provided with a high accuracy, the desired frequency at which the AC electrical grids are operated is varied slightly in a targeted manner from time to time as necessary. However, this change has hitherto been taken into account only in the case of the control power suppliers which are controlled centrally and which usually produce the above-explained secondary control power (SCP) or the minute reserve power (MRP). In this respect, it should be stated that these control power suppliers can provide in general, in particular in total, higher powers than the sources for the primary control power (PCP), which are usually controlled in a decentralized manner.

In the context of the invention it has been found that occasionally considerable quantities of energy are fed in or output monotonically as shown by an analysis of real frequency profiles by the inventors. This leads to a correspondingly high change in the state of charge for a given storage capacity. Large changes in the state of charge in turn tend to result in more rapid aging than small changes in the state of charge. Consequently, either the energy store reaches the end of its life sooner and has to be replaced sooner, or the capacity has to be increased a priori in order to reduce the relative change in the state of charge. Both result in an increase in the capital expenditure costs.

In addition, consistently complying with the guidelines for the prequalification of primary control technologies necessitates keeping corresponding power reserves available at any arbitrary time during operation and thus for any arbitrary state of charge of the energy store. This requirement (currently in Germany: the marketed primary control power for a duration of 15 min) has the effect that a corresponding capacity additionally has to be kept in reserve, this capacity increasing capital expenditure costs. In actual fact, such a reserve would (statically contingently) be utilized only very rarely.

In view of the prior art it is an object of the present invention, therefore, to provide a technically improved method for producing control power for stabilizing an AC electrical grid, which method is not beset by the disadvantages of conventional methods.

In particular, the method should be able to be carried out as simply and cost-effectively as possible. In particular, the installations with which the method can be carried out should be associated with as little capital expenditure as possible with regard to the control power provided.

In this case, the intention is to make it possible to provide control power in conjunction with a high efficiency of the components used.

A further object of the invention should be considered that of intending the capacity of the energy store to be as low as possible in order to provide the required control power.

In addition, it would also be advantageous if a reduced aging burden could be achieved. Furthermore, it would also be desirable to provide the primary control power while avoiding charging or discharging in the meantime. Alternatively, the intention should be to strive to considerably reduce at least the number of charging or discharging processes required for maintaining the operational capability.

Furthermore, it is a stated object of the present invention to find a method in which the described disturbances of the electrical grid and simultaneously trading operations are avoided or reduced. Furthermore, the method should be able to be carried out as simply and cost-effectively as possible.

Furthermore, the energy generators and energy consumers are intended to have an energy yield that is as efficient as possible as control power suppliers.

The method according to the invention is additionally intended to be suitable for being able to provide the required control power as rapidly as possible, as necessary.

Furthermore, the method should be able to be carried out with the fewest possible method steps, wherein the latter should be simple and reproducible.

Further objects not explicitly mentioned will become apparent from the overall context of the following description and the claims.

These objects and further objects which are not explicitly mentioned, but which can readily be derived or deduced from the contexts discussed in the introductory part herein, are achieved by means of a method comprising all the features of Patent claim 1. Expedient modifications of the method according to the invention for providing control power for an electrical grid are afforded protection in dependent claims 2 to 15. Furthermore, Patent claims 16 and 17 relate to a device for carrying out such a method.

Accordingly, the present invention relates to a method for producing control power for stabilizing an AC electrical grid, wherein the AC electrical grid operates at a variable desired frequency and the AC electrical grid comprises at least one control power supplier which is controlled in a decentralized manner and which controls the grid frequency to a predefined frequency, which method is characterized in that the predefined frequency is adapted to the desired frequency.

The method according to the invention makes it possible, in an unforeseeable manner, to provide a method for producing control power for stabilizing an AC electrical grid, which method is not beset by the disadvantages of conventional methods.

In particular, the present invention makes it possible to provide control power in conjunction with a high efficiency of the components used.

Furthermore, with use of galvanic components, such as rechargeable batteries, the capacity of the energy store can be kept very low in order to provide a required control power.

Furthermore, the energy generators and energy consumers have a very efficient energy yield as control power suppliers.

The method according to the invention is additionally suitable for providing the required control power very rapidly.

In particular, the method can be carried out as simply and cost-effectively as possible since the storage capacity required for full availability can be reduced or the number of charging and discharging process which have to be performed for setting the state of charge of the energy store with external energy sources or sinks can be reduced. In this case, it can be stated that the energy store can procure power via the electrical grid by energy trading. Said power has to be purchased and called up at a specific time, since otherwise a disturbance of the system is present. The actual grid frequency is unimportant for this process, since the frequency of the electrical grid is not influenced when a power is simultaneously fed in and drawn in a planned manner. What is important, rather, is that said power is fed in and drawn as synchronously as possible. Given a constant capacity of the energy store, the operational lifetime of the store can be increased owing to the reduced charging/discharging cycles, wherein this constitutes for rechargeable batteries, in particular, an important aspect which can surprisingly be improved by the present invention.

Furthermore, the control power suppliers, in particular the energy generators and/or energy consumers, can provide a sufficient quantity of positive or negative control power in a targeted manner independently of the magnitude and direction of the deviation of the grid frequency.

Furthermore, the method can be carried out with very few method steps, wherein the latter are simple and reproducible.

The present method serves for providing control power for stabilizing an AC electrical grid. As already set out in the introduction, in an AC electrical grid the frequency changes if the equilibrium between energy consumption and energy provision is not maintained.

The control energy or control power is output to the electrical grid (positive control energy or positive control power) or taken up from the electrical grid (negative control energy or negative control power). Positive control power can be fed into the grid by energy feed-in, for example energy input from an energy store, or by connecting a power station, or by restricting a consumer. Negative control power can be fed in from the grid by uptake of energy by an energy store, by restricting an energy source, for example a power station, or by connecting a consumer into the grid. Further important information in this respect can be found in the prior art, reference being made, in particular, to the documents discussed in the introductory part. It should be stated in this context that the terms control power and control energy have a similar meaning for the purposes of this invention.

Usually, control power is made available to the grid operator, for a specific nominal power from the provider. The nominal power should be understood in the present case to mean the power with which the control power source which is operated by a method according to the invention is at least prequalified. However, the prequalification power can be higher than the nominal power which is maximally made available to the grid operator. Said nominal power can also be designated as the contracted maximum power, since this power is provided as a maximum to the grid.

The method according to the invention serves for stabilizing an AC electrical grid. AC electrical grids are distinguished by a change in the polarity of the electric current, positive and negative instantaneous values complementing one another such that the current is zero on average over time. These grids are generally used for transmitting electrical energy.

Usually, the AC electrical grids are operated with a desired frequency, which is 50.000 Hz currently in Europe, particularly in Germany. In the North American area, by contrast, the desired frequency is 60.000 Hz.

As already set out above, said desired frequency is not currently fixed, but rather is slightly varied in order to adapt the so-called grid time, which serves, inter alia, as a timer for clocks, to the coordinated universal time. Consequently, such an AC electrical grid operates at a variable desired frequency. In accordance with the standards currently applicable in Europe, in the event of a deviation of ±20 seconds between the grid time and the universal time, the desired frequency is decreased or increased by 10 mHz depending on the deviation of the grid time, such that the desired frequency can currently assume values of 49.990 Hz, 50.000 Hz or 50.010 Hz. This adaptation is performed centrally by the grid operator and is taken into account when using secondary control power (SCP) and minute reserve power (MRP).

It should be stated in this context that the setting of the desired frequency when using secondary control power or minute reserve power does not necessarily require a measurement of the grid frequency at the control power sources and need not necessarily be performed by the latter themselves. Currently the power balance, for example, is used to control the use of the power producers mentioned. In this regard, the primary power is produced with solidarity throughout the entire interconnected European grid, whereas the secondary control power and the minute reserve power are requested by the responsible grid operator in each case for parts of the grid. Accordingly, the transmission of power between the different grids of the interconnected European grid and a deviation between forecast and actual values for generation and consumption are determined and used for requesting the secondary control power and/or the minute reserve power. In general, the balance is corrected beforehand with regard to the primary control power produced at the time under consideration. The power magnitude to be corrected is determined on the basis of the deviation between the grid frequency and the present desired value. This control necessitates a setting of the desired frequency of the grid by the grid operator.

The data set out above with regard to the desired frequencies and the data for adapting the grid time to the universal time serve merely for explanation purposes, without any intention to restrict the invention thereto. If appropriate, these values may deviate.

Furthermore, the grid frequency is controlled to a predefined frequency by control power suppliers that are controlled in a decentralized manner. In this case, the grid operator usually defines frequency ranges around said predefined frequency outside which positive or negative control power has to be produced. In this case, said frequency ranges are of relevance to the producers of primary control power, in particular, since primary control power is generally controlled in a decentralized manner by the provider of the primary control power. Precise details in this respect can be found in European standards (handbook) which were elaborated for operating the interconnected European system UCTE (Union for the Co-ordination of Transmission of Electricity) and are implemented in national directives (e.g. Transmission Code for Germany).

Currently, for the sources for providing primary control power, there are two tolerances that are relevant with regard to the frequency deviations. Firstly, this is the frequency measurement accuracy. The latter may be a maximum of +/−10 mHz. In addition, there is a so-called insensitivity range of a maximum +/−10 mHz that is granted to the sources which produce primary control power. In order at all events to prevent the control power sources from acting counter to the direction wanted, the transmission grid operators in Germany have stipulated in their framework agreements, for example, a band of +/−10 mHz around the desired value of 50 Hz in which no primary control power should be produced. Even with maximum frequency measurement accuracy of +10 mHz or −10 mHz, production of control power counter to the direction wanted is thus ruled out. Outside these limits, control power has to be provided in accordance with the contractual conditions.

In the event of a change in the desired frequency for adapting the grid time to the universal time it can happen, however, that control power suppliers that are controlled in a decentralized manner act counter to the direction wanted for adapting the grid time and thus prolong the duration required for adapting the grid time to the universal time, even though the relevant production of control power for stabilizing the grid is not yet necessary. By way of example, if the grid time leads the universal time by more than 20 seconds, it is necessary overall to reduce the frequency in order to obtain adaptation. For this purpose, the desired value is set to 49.990 Hz. If the present frequency is 49.985 Hz, for example, than a control power producer that is controlled in a decentralized manner produces a positive control power in accordance with the deviation relative to the standard desired frequency (50.000 Hz), since the deviation is more than 10 mHz. This positive control power tends to lead to an increase in the frequency and thus an acceleration of the grid time. On the basis of the new desired value and taking account of the frequency band of +1−10 mHz, however, there would not yet be a reason to produce positive control power (deviation relative to the new desired value less than 10 mHz), the frequency would not tend to be increased by production of control power and the adaptation of the grid time to the universal time would thus take place more rapidly.

The frequency to which control power suppliers that are controlled in a decentralized manner control, preferably primary control power producers, is called the predefined frequency in the present case in order to differentiate it from the desired frequency explained in greater detail above. Said predefined frequency has hitherto been kept constant, this value currently being 50.000 Hz In Europe. Since, according to the present invention, the control power suppliers that are controlled in a decentralized manner can now use a predefined frequency adapted to the variable desired frequency, for differentiation the term “customary predefined frequency” is used to explain the standard value of the frequency with which the AC electrical grid operates. Accordingly, the customary predefined frequency corresponds to the standard desired frequency. In the case of wanted, targeted influencing of the profile of the grid frequency in order, for example, to adapt the grid time to the co-ordinated universal time, the standard desired frequency is varied.

In general, a dead band is predefined around the predefined frequency, said dead band being required for the contractual production of control power, as has been explained above.

It should be stated in this context that what is essential to the invention is not so much the type of control power, but rather the central or decentralized control thereof. In this case, the terms decentralized and central are intended to clarify that the control takes place in two fundamentally different ways, wherein, in one case, in general, the operator of the respective grid or a corresponding entity is responsible for the activation of part of the production of control power. By contrast, the control of a further part of the production of control power is controlled by one or more further entities, for example one or more producers of primary control power, in any case independently of the grid operator. In this case, an entity can control one or more primary control power sources, which can form an interconnection, for example.

In accordance with one preferred variant, the control power supplier operating at the predefined frequency can provide primary control power. For the central control of the desired frequency, the AC electrical grid can comprise at least one supplier for secondary control power and/or minute reserve power, wherein the supplier for secondary control power and/or minute reserve power is activated in a manner taking account of the variable desired frequency.

The invention is based on the surprising insight that an adaptation of the predefined frequency, to which a control power supplier that is controlled in a decentralized manner controls the grid frequency, to the desired frequency with which the AC electrical grid is operated leads to unexpected improvements, particularly during operation of energy stores.

In this regard, surprisingly, it is possible to reduce the number of charging/discharging cycles during operation for the required adaptation of the state of charge and/or to minimize the required capacity of energy stores, wherein a reduced aging burden can be achieved. In this respect, it should be stated that, in the event of an adaptation of the predefined frequency to the present desired frequency, action counter to the wanted direction of the adaptation of the grid time to the universal time is ruled out.

In accordance with one preferred embodiment, the predefined frequency can be adapted by the desired frequency being communicated to the control power supplier that is controlled in a decentralized manner. In this case, the grid operator can transmit these data actively to the control power supplier. Alternatively, the desired frequency of the AC electrical grid can be interrogated by the controller of the control power producer that is controlled in a decentralized manner. If appropriate both methods can be used in a coordinated manner to ensure a higher reliability. For this purpose, the desired frequency can be communicated to the control power supplier by telecommunications technology, for example, wherein this can also be carried out automatically, for example using computers and corresponding data transmission, for example via the Internet.

The desired frequency should be communicated as promptly as possible such that the desired frequency currently predefined by the grid operator can be used during the adaptation thereto by the control power supplier that is controlled in a decentralized manner. It should be stated in this case that currently the planning regarding a possible adaptation of the grid time to the coordinated universal time takes place a number of hours before the actual changeover and is then valid for the minimum period of 24 hours. Accordingly, the term “promptly” means that the required information about the duration and the time of the changeover of the standard desired frequency to a desired frequency that deviates therefrom is communicated to the control power supplier that is controlled in a decentralized manner in such a timely way that this information can be taken into account when setting the predefined frequency. Preferably, the required information is communicated to the control power supplier at least 15 minutes, particularly preferably at least one hour, especially preferably at least six hours, before the actual changeover. The required information includes, for example, the magnitude of the change in the desired value of the frequency, the time and the duration of the changeover of the desired frequency.

In one preferred embodiment, provision can be made for the primary control power sources to control to the customary predefined frequency as standard, that is to say as hitherto, in the case of transmission errors, for example failure of the data communication.

Furthermore, provision can be made for a deviation between desired frequency and predefined frequency to be ascertained by a permanent frequency deviation of the grid frequency outside a frequency band over a defined period of time.

The bandwidth of the frequency band which is used for assessing a permanent frequency deviation is not critical to the present invention and can accordingly be adapted to the predefined stipulations of the grid operators. In this case, the frequency band used according to the invention for defining a deviation between desired frequency and predefined frequency can differ from the frequency range which serves to describe the production of control power in accordance with the standard predefined stipulations. In this regard hereinafter the term dead band is used to explain the production of control power in accordance with the standard predefined stipulations, whereas the term frequency band describes a range of frequencies which serves to define whether a deviation between desired frequency and predefined frequency is present, as described below.

In this case, the frequency band defined around the predefined frequency can correspond to the dead band; alternatively, it can be larger than the dead band. In accordance with one preferred alternative, the dead band can be larger than the frequency band. It should be stated in this context that the primary control power producers generally control to a fixed predefined frequency, while the secondary control power producers, in the event of an adaptation of the grid time to the coordinated universal time, control to a desired frequency that differs from the predefined frequency by ±10 mHz. In this case, it should be taken into consideration that at least some of the primary control power producers can produce control power counter to the control by the secondary control power producers. Accordingly, the average grid frequency will generally deviate from the predefined frequency to a lesser extent than the desired frequency, if no unexpected disturbances of the grid occur.

Preferably, the frequency band can have for example a width of at most 18 mHz, preferably at most 16 mHz, particularly preferably at most 14 mHz and especially preferably at most 12 mHz. This results in frequency bands which, in Europe, for example, are preferably in the range of 49.991 Hz to 50.009 Hz, preferably in the range of 49.992 Hz to 50.008 Hz, particularly preferably in the range of 49.993 Hz to 50.007 Hz and especially preferably in the range of 49.994 Hz to 50.006 Hz.

Depending on the variation of the standard desired frequency, this frequency band can also be larger than the dead band. If, for example, the dead band is defined to be narrower than the values set out above, but the values set out above for matching the grid time to the coordinated universal time are maintained, it may be expedient to choose the frequency band to be wider. In this case, it should be stated that the values set out above are described for explaining the present invention, without intending any restriction thereto. What is essential, therefore, is not so much the dead band, but rather the variation range of the desired frequency.

Preferably, a unit with a high measurement accuracy can be used for determining the grid frequency, in particular the average grid frequency. One particularly preferred embodiment of the invention can provide for the frequency deviation to be measured with an inaccuracy of a maximum of ±8 mHz, particularly preferably of a maximum of ±4 mHz, very particularly preferably of a maximum of ±2 mHz, especially preferably of a maximum of ±1 mHz.

According to the present invention, an adaptation of the predefined frequency to the desired frequency can be performed in the event of a permanent frequency deviation outside the frequency band over a defined period of time. Accordingly, a check is made to determine whether the grid frequency is permanently outside the frequency band defined around the predefined frequency. An adaptation of the predefined frequency to the desired frequency can be performed in the event of a permanent deviation of the grid frequency over a defined period of time.

The defined period of time depends on the requirements of the grid operator and can accordingly be variable. In accordance with the regulations currently applicable in Europe, a primary control power source must be able to produce the primary control power at least for a period of 15 minutes. Different regulations are applicable in America, although the present invention, in principle, is not intended to be restricted to a specific region or a specific set of regulations. Advantageously, the defined period of time can be, for example, in the range of zero minutes to 24 hours, preferably 1 minute to 8 hours, preferably 2 minutes to 1 hour and particularly preferably 5 minutes to 30 minutes.

There is a permanent frequency deviation outside the frequency band if, over the defined period of time as set out above, the grid frequency is at least 60%, preferably at least 80%, preferably at least 90%, especially preferably at least 95% and particularly preferably at least 99%, either above or below the frequency band.

In accordance with one particularly preferred embodiment, a permanent frequency deviation outside the frequency band means that the frequency is outside the frequency band over the entire period of time.

If there is a permanent frequency deviation outside the frequency band over a defined period of time, the predefined frequency of the energy store can be changed to a variable control frequency, in particular a variable desired frequency, after said defined period of time. In this case, it is possible to carry out control to a previously stipulated frequency which, depending on the deviation, can be above or below the predefined frequency band. By way of example, when the prerequisites defined above occur, it is possible to stipulate a control frequency which is, for example, 5 mHz, 8 mHz, 10 mHz higher or lower than the customary predefined frequency, depending on the type of previously ascertained permanent deviation of the grid frequency. Preferably, it is possible to carry out control to an assumed variable desired frequency, which currently in Europe is 49.990 Hz or 50.000 Hz or 50.010 Hz, wherein these values can be adapted, if appropriate.

In accordance with one preferred embodiment, by means of sliding averaging of the grid frequency it is possible to determine whether the predefined frequency can be adapted to a variable desired frequency.

Moving averaging means that not all of the data points are used for calculating the average value, but rather only some of them. Preferably, the data which were determined over a period of time corresponding at most to triple, preferably at most to double, the stipulated period of time defined previously are taken into account for calculating the moving average. In particular, it is also possible for only part of the stipulated period of time defined previously to be involved. By way of example, the period of time over which the values for determining the moving average are collected can be in the range of 3 minutes to 2 hours, preferably 5 minutes to 1 hour and particularly preferably 10 minutes to 30 minutes.

In this case, the average values can be formed in a wide variety of ways, such as, for example, a simple shift, without weighting of the data (simple moving average (SMA)). In accordance with one preferred embodiment, a weighted moving average (WMA), in which the more recent data preferably have a higher weight than the older data, can be used for determining the variable frequency. In this case, a simple weighting can be performed or an exponential smoothing can be carried out. In this case, the number of data points depends on how often the frequency measurement is performed, wherein the average values of the data can also be used for reducing the memory space. In accordance with one preferred embodiment, at least 10 data points which can be used for determining the average value are formed within a period of time of 1 minute.

In accordance with one preferred embodiment, an adaptation of the predefined frequency, towards which a primary control power source preferably operates, to a desired frequency that is preferably taken as a basis when activating a secondary control power source or a source for a minute reserve power is not mandatory, but rather operational.

In accordance with this embodiment, it is possible to check whether a change in the production of control power to a variable desired frequency leads to an optimization of the state of charge. In this context, in the case of a corresponding state of charge, it is also possible to maintain standard control according to which control power is produced in the event of a deviation from the predefined frequency, although a change to a variable desired frequency would be possible. In this case, within a period of time for which the variable desired frequency is changed from a standard value to a value that deviates therefrom, a multiple adaptation of the predefined frequency from the original value to a variable desired value can be performed if the adaptation of the predefined frequency was occasionally reversed during said period of time.

In one particularly preferred embodiment, the adaptation of the predefined frequency from the original value to an altered desired value can be repeatedly performed and also reversed again, even though the desired value was not altered in the relevant time. By way of example, the desired value can be reduced from 50.000 Hz to 49.990 Hz for the duration of one day and the predefined frequency is adapted to the new value at least once in the course of the same day and is reset to the original predefined frequency again before the day has actually elapsed. In one preferred embodiment, the change from the original predefined frequency to the new desired value takes place to and fro more than once, that is to say to at least twice and fro at least once.

In accordance with one particular embodiment, the feeding of energy into the energy store may be dependent on the time of day. As a result it is possible to ensure a high stability of the grid even in the case of a high load at specific times of day. In this regard, in the case of peak loads, it is possible to rule out a regeneration of the energy store that would be practical on account of the deviation of the grid frequency from the predefined frequency over a relatively long period of time.

In one especially preferred embodiment, the change between the original predefined frequency and a desired frequency that differs therefrom can be ruled out under specific boundary conditions. By way of example, this can be made dependent on the present frequency gradients (change in the frequency deviation with time), the absolute frequency deviation and/or the time of day. In the last-mentioned case, it is possible to ensure a high stability of the grid even in the case of a high load at specific times of day. In this regard, for example, in the case of peak loads, it is possible to rule out a regeneration of the energy store that would be practical on account of the deviation of the grid frequency from the predefined frequency over a relatively long period of time.

The control deviating from the customary predefined frequency can be maintained over an arbitrary period of time. A return to the provision of control power in accordance with the standard predefined stipulations, which involves controlling to the customary predefined frequency, can be obtained, for example, by the control to the variable desired frequency being ended in the case of a predefined state of charge of an energy store that is preferably to be used as control power supplier.

Furthermore, a check can be carried out to determine whether the grid frequency is in the frequency band defined around the customary predefined frequency over a relatively long period of time without special measures. In this embodiment, the average grid frequency can be determined by weighted averaging, for example. If this check reveals that the average grid frequency is in the frequency band over a relatively long period of time, the control to a variable desired frequency can be reversed, such that control to the customary predefined frequency is carried out.

Said relatively long period of time is not subject to any specific conditions, and so it can be chosen arbitrarily. By way of example, said relatively long period of time can be identical to the defined period of time that was determined with regard to the permanent frequency deviation. Furthermore, said relatively long period of time can also be significantly shorter, and so said period of time can be for example in the range of 1 second to 1 hour, preferably 1 minute to 30 minutes.

Provision can furthermore be made for the control to a variable desired frequency to be ended when the frequency enters into the previously defined frequency band or attains some other frequency value.

Alternatively, it can be provided that, after a predefined time duration over which control to a variable desired frequency was carried out, this exceptional control is reversed and control to the customary predefined frequency is carried out in accordance with the regulations. In this regard the grid operator can provide, for example, a temporal limitation of the change in the control frequency, such that control to the customary predefined frequency is carried out for example after at most 2 days, preferably after at most one day, preferably after at most 6 hours, and particularly preferably at most 2 hours.

A further preferred embodiment consists in the fact that the method according to the invention is practiced only by a portion of the primary control power producers, in particular stores, or up to a maximum total primary control power to be produced by these sources.

In a further embodiment, the periods of time defined as set out above and the adaptation of the predefined frequency are defined differently for relatively lengthy deviations of the frequency upwards than for relatively lengthy deviations of the frequency downwards.

It should be stated in this context that the method makes it possible to achieve a contribution for stabilizing the grid even in the case of a relatively low capacity of the energy store since provision of control power can also take place if the grid frequency, over a very long period of time, is outside the dead band within which no control is necessary.

In accordance with one particular embodiment, a regeneration of the energy store can take place even if the measured frequency is outside one limit of a dead band for a relatively long period. This embodiment is suitable for optimizing the state of charge particularly in connection with the manner of utilizing tolerances for example with regard to the level of producing control power, the time within which the control power should be produced, and the frequency tolerances.

By way of example, negative control power can be provided to an increased extent if the state of charge of the energy store is very low on account of a grid frequency which is below the predefined frequency on average over a relatively long period of time. In this case, tolerances, for example the tolerances permitted for the control power producer by the grid operator, with regard to the grid frequency, the magnitude of the control power depending on the frequency deviation, the insensitivity with regard to the frequency change, and the period of time within which the control power should be produced, can be utilized in order to adapt the state of charge of the energy store to the requirements. In this regard, instead of the envisaged negative control power, for example at least 105%, preferably at least 110% and particularly preferably at least 115% of said control power can be produced. If positive control power then has to be provided in the case of a low state of charge, the power that is contractually to be produced is provided as accurately as possible in this case. Furthermore, energy can be taken up directly in the case of a low state of charge, while energy is fed in at the latest possible time in accordance with the regulations or with the slowest possible rise in accordance with the regulations. Furthermore, the frequency tolerance allowed by the grid operator can be used by virtue of a measurement being carried out with a higher accuracy, the difference obtained thereby with respect to the allowed measurement inaccuracy being used in a targeted manner, in order, in accordance with the regulations, i.e. within the given tolerance framework, in the case of a low state of charge, to feed as little power as possible into the grid or to take up as much power as possible from the grid. The procedure the other way around can be adopted in the case of a high state of charge. In this regard, by way of example, a high energy output in the case of providing a positive control power and a low energy uptake in the case of providing a negative control power are possible or can be realized.

The tolerance with regard to the absolute value of the control power provided and the tolerance when determining the frequency deviation, etc. should be understood, according to the invention, to mean that certain deviations between an ideal desired power and the control power actually produced are accepted by the grid operator, on account of technical boundary conditions, such as the measurement accuracy when determining the control power produced or the grid frequency. The tolerance can be granted by the grid operator, but could also conform to a legal predefined stipulation.

In accordance with one particular embodiment, the feeding of energy into the energy store may be dependent on the time of day. As a result it is possible to ensure a high stability of the grid even in the case of a high load at specific times of day. In this regard, in the case of peak loads, it is possible to rule out a regeneration of the energy store that would be practical on account of the deviation of the grid frequency from the predefined frequency over a relatively long period of time.

Furthermore, provision can be made for a plurality of energy stores to be used according to the present method. In one particular embodiment, in this case all or only some of these energy stores can produce control power adapted to the state of charge of the energy stores, as was explained above.

The size of the energy stores within the pool can vary in this case. In one particularly preferred embodiment, in the case of the various energy stores of a pool with the utilization of tolerances, in particular the choice of the bandwidth in the dead band, the change from one parameter setting to another is not performed synchronously but rather deliberately with a temporal offset, in order to keep possible disturbances in the grid as small as possible or at least tolerable.

In a further preferred embodiment the tolerances used in the various procedures, in particular the choice of the bandwidth in the dead band, vary depending on the time of day, the day of the week or the season. By way of example, tolerances can be defined more narrowly in a period of from 5 min before to 5 min after the hour change. This is owing to the fact that very rapid frequency changes often take place here. It may be in the interests of the transmission grid operators for there to be lower tolerances here and thus for the control energy to be provided more certainly in the sense of more rigorously.

In accordance with a further embodiment, in the context of the predefined stipulations for producing control power, provision can be made for the control power supplier that is controlled in a decentralized manner to take up on average more energy from the grid than it feeds in. This can be implemented by virtue of the fact that preferably a very large amount of negative control power is provided in accordance with the regulations including the procedure set out above, whereas preferably only the minimum assured attainment of positive control power is produced in accordance with the regulations including the procedure set out above. Preferably, on average at least 0.1% more energy is drawn from the grid than is fed in, in particular at least 0.2%, preferably at least 0.5%, particularly preferably at least 1.0%, especially preferably 5%, these values being relative to an average which is measured over a period of at least 15 minutes, preferably at least 4 hours, particularly preferably at least 24 hours, and especially preferably at least 7 days, and relating to the energy fed in.

In this case, the production of control power as set out above can be used in a targeted manner in order to draw a maximum of energy from the grid, wherein the maximum possible negative control power is provided, whereas only a minimum of positive control power is produced.

In the embodiments for the preferred and especially for the maximum energy uptake, the energies drawn from the grid as a result can be sold by means of the energy trading described above, this preferably taking place at times when the highest possible price can be obtained. For this purpose, it is possible to consult price trend forecasts that are based on historical data.

Furthermore, the state of charge at the time of planned selling of energy may preferably be at least 70%, particularly preferably at least 80%, and particularly preferably at least 90%, of the storage capacity, the state of charge after selling preferably being at most 80%, in particular at most 70%, and particularly preferably at most 60%, of the storage capacity.

In the case of a permanent frequency deviation outside the frequency band, the control power can be produced in accordance with the customary regulations that are also instituted for short-term control of the grid frequency. In Europe, in accordance with the currently applicable regulations, the absolute value of the power to be produced should be increased largely linearly with increasing frequency deviation from the predefined frequency. In this regard, a control power amounting to 50% of the maximum power is usually produced in the case of a deviation of 100 mHz. Said maximum power is produced in the case of a deviation of 200 mHz and corresponds to the above-defined nominal power or contracted maximum power for which the energy store is at least prequalified. Accordingly, 25% of the nominal power is produced in the case of a deviation of 50 mHz.

This control can be maintained, though with the above-explained change in the customary predefined frequency to a variable desired frequency. In this case, the frequency values at which the maximum power or nominal power should be produced can be correspondingly shifted. Alternatively, these frequencies can be maintained.

According to the invention, the method is carried out with one control power producer. Control power producers are, in particular, energy stores, energy generators and energy consumers.

According to the invention, provision can be made for the energy generator used to be a power station, preferably a coal power station, a gas power station or a hydroelectric power station, and/or for the energy consumer used to be a factory for manufacturing a substance, in particular an electrolysis factory or a metal factory, preferably an aluminium factory or a steel factory.

Such energy generators and energy consumers are well suited to providing relatively long-term control powers. The inertia thereof does not constitute an obstacle according to the invention, if they are suitably combined with dynamic stores.

An energy store which can take up and output electrical energy is preferably used for carrying out the method. The type of energy store is not essential to the implementation of the present invention.

Preferably, provision can be made for the energy store used to be a flywheel, a heat accumulator, a hydrogen generator and store with fuel cell, a natural gas generator with gas power station, a pumped-storage power station, a compressed-air energy storage power station, a superconducting magnetic energy store, a redox flow element and/or a galvanic element, preferably a rechargeable battery or combinations (“pools”) of stores or of stores with conventional control power sources or of stores with consumers and/or energy generators.

A heat accumulator operated as an energy store has to be operated together with a device for producing electricity from the stored thermal energy.

Battery stores (rechargeable batteries) are distinguished by comparison with conventional technologies for providing primary and/or secondary control powers by the fact, inter alia, that they can change the produced powers significantly more rapidly. In most cases, however, what is disadvantageous about battery stores is that they have a comparatively low storage capacity, that is to say that they can produce the required powers only over a limited period of time. In the case of statistical evaluation of the frequency deviations over time, in the context of the present invention it was surprisingly found that the required powers in more than 75% of the active time (that is to say that a power deviating from zero is produced) amount to less than 20% of the maximum power or of the marketed power.

From this insight according to the invention it is likewise evident that the capacity of the energy store and thus the stored quantity of control power to be kept available can be chosen to be smaller, and a method according to the invention can particularly successfully keep the capacity of the energy store small.

Specific and particularly preferred embodiments of the solution approaches consist in the fact that the energy store is a rechargeable battery or a battery store that is used for producing primary control power.

In a further specific embodiment, the energy taken up into the energy store in the case of negative PC power can be disposed of on the spot market, particularly if the conditions there are advantageous.

The rechargeable batteries include, in particular, lead-acid rechargeable batteries, sodium-nickel chloride rechargeable batteries, sodium-sulphur rechargeable batteries, nickel-ion rechargeable batteries, nickel-cadmium rechargeable batteries, nickel-metal hydride rechargeable batteries, nickel-hydrogen rechargeable batteries, nickel-zinc rechargeable batteries, tin-sulphur-lithium-ion rechargeable batteries, sodium-ion rechargeable batteries and potassium-ion rechargeable batteries.

In this case, preference is given to rechargeable batteries having a high efficiency and a high operational and calendrical lifetime. The preferred rechargeable batteries accordingly include, in particular, lithium-ion rechargeable batteries (e.g. lithium-polymer rechargeable batteries, lithium-titanate rechargeable batteries, lithium-manganese rechargeable batteries, lithium-iron-phosphate rechargeable batteries, lithium-iron-manganese-phosphate rechargeable batteries, lithium-iron-yttrium-phosphate rechargeable batteries) and further developments thereof, such as, for example, lithium-air rechargeable batteries, lithium-sulphur rechargeable batteries and tin-sulphur-lithium-ion rechargeable batteries.

Lithium-ion rechargeable batteries, in particular, are particularly suitable for methods according to the invention on account of their fast reaction time, that is to say both with regard to the response time and with regard to the rate with which the power can be increased or reduced. In addition, the efficiency is also good particularly in the case of Li-ion rechargeable batteries. Furthermore, preferred rechargeable batteries exhibit a high ratio of power to capacity, this characteristic value being known as the C-rate.

Provision can also be made for making it possible to store in the energy store an energy of at least 4 kWh, preferably of at least 10 kWh, particularly preferably at least 50 kWh, especially preferably at least 250 kWh.

In accordance with one further configuration, the energy store can have a capacity of 1 Ah, preferably 10 Ah and particularly preferably 100 Ah.

With the use of stores based on electrochemical elements, in particular rechargeable batteries, this store can advantageously be operated with a voltage of at least 1 V, preferably at least 10 V, and particularly preferably at least 100 V.

Depending on the profile of the frequency deviation, control power can be fed into the AC electrical grid in a constant fashion, by means of pulses or by means of ramps, characterized by a rise in the feeding-in of power over a defined period of time.

A control power provided by means of pulses makes it possible to improve the efficiency of the device and the method for providing control power, since, as a result, the power electronics required, particularly with the use of rechargeable batteries, can be operated at a higher efficiency. A pulse should be understood to mean a temporally limited jerky current, voltage or power profile, wherein these pulses can also be used as a repeating sequence of pulses. The duty cycle according to DIN IEC 60469-1 can be chosen here depending on the type of power electronics and the control power to be produced, said duty cycle being in the range of greater than zero to 1, preferably in the range of 0.1 to 0.9, particularly preferably in the range of 0.2 to 0.8.

In the case of power changes that become necessary, provision can preferably be made for the power of the energy store to be increased depending on the magnitude of the required power change over a period of at least 0.5 s, preferably over a period of at least 2 s, particularly preferably over a period of at least 30 s.

These slower ramps ensure that excitations of undesired disturbances or oscillations in the electrical grid or at the connected consumers and generators as a result of an excessively steep power gradient do not occur.

The sought state of charge of the energy store can preferably be in the range of 20 to 80% of the capacity, particularly preferably in the range of 40 to 60%. The compliance with and/or return to these state-of-charge ranges can be achieved, for example, by the use of the operating procedure on which this invention is based, and/or by means of the energy trading explained in greater detail above, via the electrical grid. The state of charge corresponds, in particular in the case of rechargeable batteries as energy store, to the state of charge (SoC) or to the state of energy (SoE).

The sought state of charge of the energy store may depend on predicted data. In this regard, consumption data, in particular, can be used for determining the optimum state of charge, said consumption data being dependent on the time of day, the day of the week and/or the season.

Provision can also be made for the power of the energy store that is output to the electrical grid or the power of the energy store that is taken up from the electrical grid, after a permanent frequency deviation outside the frequency band, to be measured at a plurality of times, in particular continuously, and for the state of charge of the energy store to be calculated at a plurality of times, preferably continuously, wherein the power of the energy store that is output or taken up is set depending on said state of charge in such a way that the variable desired frequency is taken into account when taking up or outputting power.

In accordance with one particular embodiment of the present invention, the method can be carried out with an additional energy generator and/or energy consumer. In this context, additional energy generators and/or energy consumers are devices which can provide control power, but which do not constitute an energy store.

In this case, preference is given, in particular, to such additional energy generators and/or energy consumers which can also be used in connection with renewable energies, such as, for example, electrolysis factories or metal factories, the production of which can be reduced for providing positive control power.

As a result of this embodiment, surprisingly, the nominal power of the energy store can be increased, without the capacity thereof having to be increased. In this case, the energy store can be provided with power by the additional energy generators and/or energy consumers even in the case of high grid loading in a very short time as necessary, without prolonged energy trading being necessary. Surprisingly, therefore, given a relatively low capacity of the store, a relatively high power can be output, which can generally be output only for a short period of time. As a result of the additional energy generator and/or energy consumer being accessed directly, it can, after a short time, produce or substitute the control power that is actually to be made available by the energy store. In this regard, in particular, the energy store can be regenerated by the energy or power of the additional energy generator and/or energy consumer. In this case, the energy store contributes to the quality of the production of control power, since a fast reaction time is achieved thereby. In contrast thereto, the additional energy generator and/or energy consumer contributes primarily to the quantity, since it can supply control power at relatively low costs over a significantly longer time governed by the design.

Furthermore, provision can be made for the energy generator and/or the energy consumer individually or in the pool to have a power of at least 10 kW, preferably at least 100 kW, particularly preferably at least 1 MW, and especially preferably of at least 10 MW.

The ratio of the nominal power of the energy store to the maximum power of the additional control power producer can preferably be in the range of 1:10000 to 100:1, particularly preferably in the range of 1:1000 to 40:1.

The method of the present invention can preferably be carried out by a device which comprises a controller and an energy store, wherein the device is connected to an electrical grid and the controller is connected to the energy store, wherein the controller is connected to a unit for determining the time duration and a unit for determining an average grid frequency.

In this case, provision can be made for the device to comprise a frequency measuring unit for measuring the grid frequency of the electrical grid and a data memory, wherein at least one limit value (for example predefined frequency ±10 mHz, predefined frequency ±200 mHz etc.) of the grid frequency is stored in the memory, wherein the controller is designed to compare the grid frequency with the at least one limit value and to control the power of the energy store and, if appropriate, of the energy consumer and/or of the energy generator depending on the comparison.

According to the invention, in the present case a controller is understood to mean a simple open-loop controller. In this case, it should be noted that any closed-loop controller encompasses open-loop control since a closed-loop controller carries out control over and above open-loop control in a manner dependent on a difference between an actual value and a desired value. Preferably, therefore, the controller is embodied as a closed-loop controller, in particular with regard to the state of charge. Particularly preferably, the controller is a control system.

Furthermore, provision can be made for the unit for determining the time duration to have a data memory, wherein at least historical data regarding the deviation and the duration of the grid frequency from the predefined frequency are held in the data memory, wherein said historical data encompass a period of preferably at least one day, preferably at least one week, particularly preferably at least one month and especially preferably at least one year. The unit for determining an average grid frequency can be embodied according to the type of averaging. In general, the control unit will comprise a data memory which contains the variable desired frequencies defined for adapting the grid time to the coordinated universal time.

Alternatively, the data are collected at a remote site and evaluated as set out above and the corresponding signal is suitably transmitted to the store or stores for providing control power. In one particularly preferred embodiment, this can be carried out by means of the known methods of remote data transmission and communication.

Exemplary embodiments of the invention are explained below with reference to three schematically illustrated figures, but without restricting the invention here. In detail:

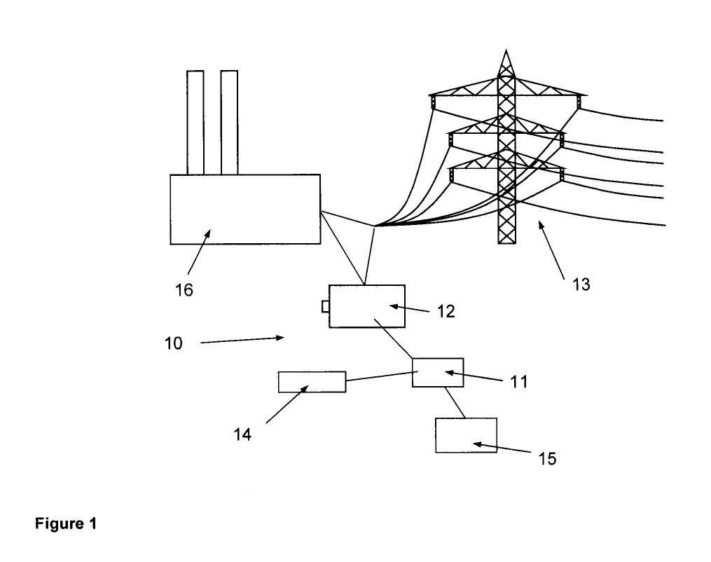

FIG. 1: Shows a schematic illustration of a device according to the invention for providing control power;

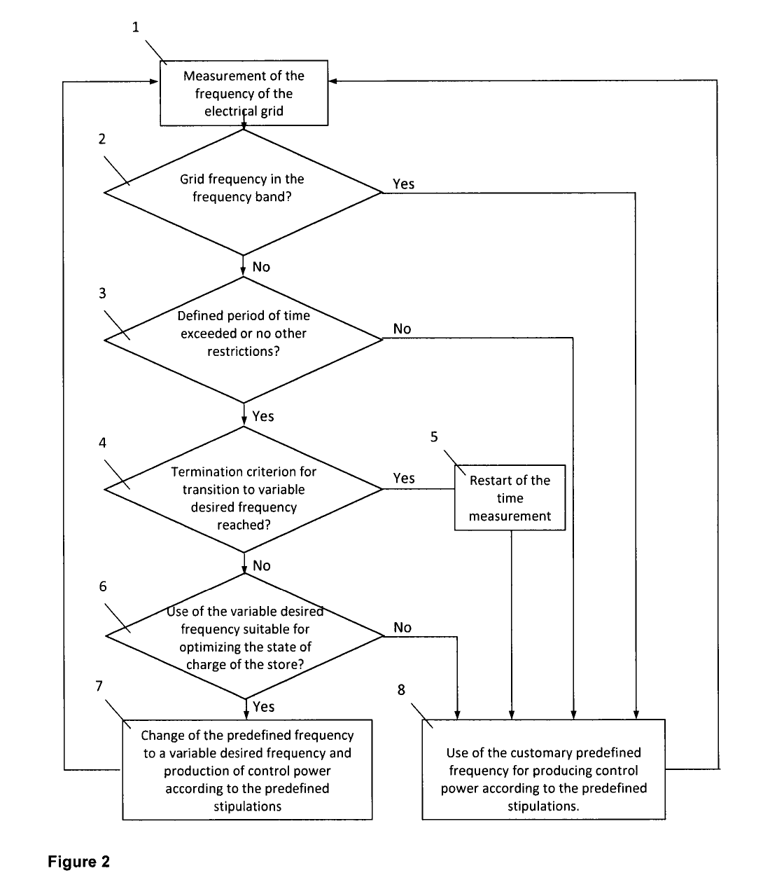

FIG. 2: Shows a flow chart for a first embodiment of a method according to the invention and

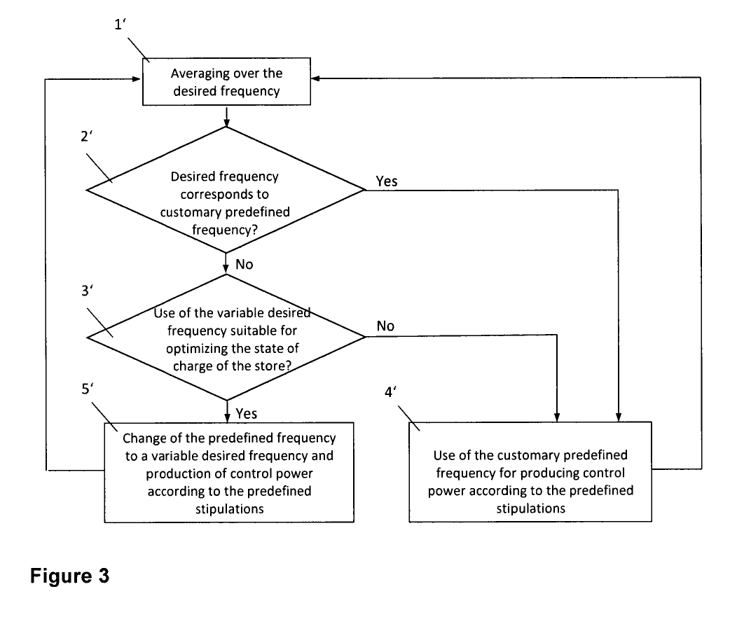

FIG. 3: Shows a flow chart for a second embodiment of a method according to the invention.

FIG. 1 shows a schematic construction of a preferred embodiment of a device 10 according to the invention for a method according to the invention, comprising a controller 11 and an energy store 12, wherein the device is connected to an electrical grid 13.

In particular in such cases, too, an energy store 12 that reacts particularly fast and can easily be charged and discharged is particularly advantageous. Rechargeable batteries are best suited for this purpose. Li-ion rechargeable batteries in particular can be charged and discharged rapidly and frequently with minor harmful influences on the rechargeable battery, and so they are particularly suitable and preferred for all exemplary embodiments according to the invention. Li-ion rechargeable batteries having a considerable capacity have to be provided for this purpose. Said rechargeable batteries can be accommodated easily for example in one or more 40-foot ISO containers.

In this case, the controller 11 is connected to the energy store 12. Furthermore, the controller 11 is connected to a unit for determining the time duration 14 and a unit for determining an average grid frequency 15. These units can, of course, be spatially accommodated in a housing with the controller. The connection between the unit for determining the time duration 14 and the unit for determining an average grid frequency 15 with the controller 11 allows communication of the data determined, which are processed in the controller unit. Furthermore, the controller 11 can be connected to the electrical grid 13, wherein this connection (not illustrated in FIG. 1) can allow communication of enquiries for required control power, both positive and negative.

The embodiment set out in FIG. 1 has an additional energy generator and/or energy consumer 16, which constitutes an optional component in the present invention. The additional energy generator and/or energy consumer 16 is connected both to the electrical grid 13 and to the energy store 12, such that the control power provided by the additional energy generator and/or energy consumer can be fed directly into the electrical grid 13 or can be used for regenerating the energy store 12. The additional energy generator and/or energy consumer 16 can be controlled by conventional components which can be connected to the controller 11 of the device 10 according to the invention.

For details concerning the control of control power and the exchange of information with the grid operators, reference should be made to the Forum For Grid Technology/Grid Operation at the VDE (FNN) “TransmissionCode 2007” from November 2009.

FIG. 2 shows a flow charge for a first embodiment of a preferred method according to the present invention. In this embodiment, no indications regarding the present desired frequency are communicated by the grid operator, and this information also cannot be interrogated by the control power producer. Rather, in this embodiment, the currently applicable desired frequency is determined by measurement of the grid frequency. An energy store is used in the method set out in FIG. 2. In step 1, the grid frequency of the electrical grid is measured. In decision step 2, a check is then made to determine whether the grid frequency is within or outside the frequency band that was defined beforehand. Said frequency band can be identical to a dead band predefined by the grid regulations or by the grid operator. Preferably, said frequency band can be smaller than the dead band determined by the grid operators or by the grid regulations.

If the measured grid frequency is within the frequency band, in accordance with the present embodiment of the method, control power is produced in accordance with the standard predefined stipulations, as is illustrated in step 8.

If the grid frequency deviates from the predefined frequency, in decision step 3 a check is made to determine whether a permanent frequency deviation is present over a defined period of time. In this case, it is likewise possible to check whether there is some other restriction that rules out a deviation from the standard predefined stipulations. By way of example, it may be provided that control to the predefined frequency is mandatory at specific times of day. If there is no permanent frequency deviation or control to a variable desired frequency is ruled out, control power is produced in accordance with the customary predefined stipulations, control to the predefined frequency being carried out. If a permanent frequency deviation is present and no exceptional control is applicable, the method continues with decision step 4.

In decision step 4 a check is made to determine whether a termination criterion is present, such that a transition from control with a variable desired frequency to control with the predefined frequency must take place. These termination criteria may be provided, for example, by a period of time to which production of control power with a variable desired frequency is limited. Furthermore, a state of charge that allows control to the predefined frequency may have been achieved as a result of a regeneration of the energy store. In this case, in the present embodiment, in accordance with step 5, the time measurement with regard to the predefined period of time for which a permanent frequency deviation must be present before control to a variable desired frequency is permissible is restarted. Afterwards, control power is produced in accordance with the customary predefined stipulations using the predefined frequency, as is illustrated schematically in step 8.

If said termination criterion is not fulfilled, in the present embodiment in decision step 6 a check is made to determine whether the application of control power production using a variable desired frequency is expedient for transferring the state of charge of the energy store to a sought state of charge in the shortest possible time. If this is not the case, the customary predefined frequency is used for producing the control power.

By way of example, the desired frequency can be at a value of 49.990 Hz in order to adapt the grid time to the co-ordinated universal time. If the energy store then has a relatively high state of charge and the energy store should accordingly preferably output energy, it is expedient to leave the predefined frequency at 50.000 Hz and to provide increasingly or higher positive control power.

Otherwise, the method proceeds in accordance with step 7, and the predefined frequency is adapted to the desired frequency. In a manner similar to the case set out above, the energy store can have a relatively high state of charge. However, the desired frequency this time is intended to be at a value of 50.010 Hz. In this case, it is expedient to adapt the predefined frequency to the changed desired frequency in order that as much positive control power as possible has to be provided.

Subsequently the grid frequency is once again measured, thus resulting in a circuit. This also applies to the case where the control power production is produced in accordance with the standard predefined stipulations, as described in step 8.

The order of the steps set out in FIG. 2 can partly be rearranged. In this regard, in particular, decision step 6 can be carried out before decision step 4, such that the check regarding the expediency of control to a variable control frequency is carried out before a termination criterion is present.

FIG. 3 shows a flow chart for a second embodiment of a preferred method according to the present invention. In this embodiment, indications regarding the present desired frequency are communicated by the grid operator. This can be carried out on the initiative of the grid operator. Alternatively, this information can also be interrogated by the control power producer that is controlled in a decentralized manner.

In step 1′ the present desired frequency is communicated to the control power producer. In decision step 2′, a check is made to determine whether said desired frequency corresponds to the customary predefined frequency. If this is the case, in accordance with step 4′ control power is produced in accordance with the predefined stipulations using the customary predefined frequency.

If the desired frequency deviates from the customary predefined frequency, then in decision step 3′ a check is made to determine whether the application of the control power production using a variable desired frequency is expedient for transferring the state of charge of the energy store to a sought state of charge in the shortest possible time. If this is not the case, in accordance with step 4′ the customary predefined frequency is used for producing the control power.

By way of example, the desired frequency can be at a value of 49.990 Hz in order to adapt the grid time to the co-ordinated universal time. If the energy store then has a relatively high state of charge and the energy store should accordingly preferably output energy, it is expedient to leave the predefined frequency at 50.000 Hz and to provide increasingly or higher positive control power.

Otherwise, the method proceeds in accordance with step 5′, and the predefined frequency is adapted to the desired frequency. In a manner similar to the case set out above, the energy store can have a relatively high state of charge. However, the desired frequency this time is intended to be at a value of 50.010 Hz. In this case, it is expedient to adapt the predefined frequency to the changed desired frequency in order that as much positive control power as possible has to be provided.

The features of the invention disclosed in the above description and also in the claims, figures and exemplary embodiments may be essential to the realization of the invention in its various embodiments both individually and in any desired combination.

1-17. (canceled)

18. A method for producing control power for stabilizing an AC electrical grid,
wherein the AC electrical grid operates at a variable desired frequency and the AC electrical grid comprises at least one control power supplier which is controlled in a decentralized manner and which controls the grid frequency to a predefined frequency, and
wherein the predefined frequency is adapted to the variable desired frequency.

19. A method according to claim 18, wherein the control power supplier operating at the predefined frequency provides primary control power.

20. A method according to claim 18, wherein the AC electrical grid comprises at least one supplier for secondary control power and/or minute reserve power which is controlled centrally, wherein the supplier for secondary control power and/or minute reserve power is activated in a manner taking account of the variable desired frequency.

21. A method according to claim 18, wherein the control power supplier operating at the predefined frequency is an energy store which can take up and output electrical energy.

22. A method according to claim 21, wherein a state of charge of the energy store is taken into account during adaptation of the predefined frequency to the variable desired frequency.

23. A method according to claim 21, wherein the energy store is a rechargeable battery.

24. A method according to claim 23, wherein the rechargeable battery is a lithium-ion rechargeable battery.

25. A method according to claim 18, wherein the variable desired frequency is communicated to the control power supplier which is controlled in a decentralized manner.

26. A method according to claim 18, wherein a deviation between variable desired frequency and predefined frequency is ascertained by a permanent frequency deviation of the grid frequency outside a frequency band over a defined period of time.

27. A method according to claim 26, wherein a deviation between variable desired frequency and predefined frequency is determined by moving averaging of the grid frequency.

28. A method according to claim 18, wherein a dead band around the predefined frequency is predefined.

29. A method according to claim 28, wherein a deviation between variable desired frequency and predefined frequency is ascertained by a permanent frequency deviation of the grid frequency outside a frequency band over a defined period of time, wherein the deviation of the grid frequency from the predefined frequency is measured with a higher accuracy than the width of the dead band.

30. A method according to claim 29, wherein the frequency band used for determining a permanent frequency deviation of the grid frequency is smaller than the dead band.

31. A method according to claim 18, wherein, in context of the predefined stipulations for producing control power, by the control power supplier which is controlled in a decentralized manner, on average more energy is taken up from the grid than is fed in.

32. A method according to claim 18, wherein, within a period of time for which the variable desired frequency is changed from a standard value to a value that deviates therefrom, a multiple adaptation of the predefined frequency from the original value to a variable desired value is performed if the adaptation of the predefined frequency was occasionally reversed during the period of time.

33. A device for carrying out a method according to claim 18, comprising a controller and an energy store, wherein the device is connected to an electrical grid and the controller is connected to the energy store, wherein the controller is connected to a unit for determining a time duration and a unit for determining an average grid frequency.

34. A device according to claim 33, wherein the unit for determining an average grid frequency has a higher measurement accuracy than a dead band defined around the predefined frequency.
